(19) United States
(12) Patent Application Publication
(10) Pub. No.: US 2025/0385392 A1
(43) Pub. Date: Dec. 18, 2025

(54) BATTERY MODULE

(71) Applicants: HYUNDAI MOTOR COMPANY, Seoul (KR); KIA CORPORATION, Seoul (KR)

(72) Inventors: Gyung Hoon Shin, Hwaseong-si (KR); Hae Woong Jung, Hwaseong-si (KR)

(73) Assignees: HYUNDAI MOTOR COMPANY, Seoul (KR); KIA CORPORATION, Seoul (KR)

(21) Appl. No.: 19/193,356

(22) Filed: Apr. 29, 2025

(30) Foreign Application Priority Data
Jun. 12, 2024 (KR) 10-2024-0076566
Feb. 11, 2025 (KR) 10-2025-0017451

(51) Int. Cl. H01M 50/507; H01M 10/6554; H01M 50/211; H01M 50/271

(52) U.S. Cl. CPC H01M 50/507; H01M 10/6554; H01M 50/211; H01M 50/271

(57) ABSTRACT

A battery module includes a battery stack including a plurality of battery cells, a holder member provided at one side of the battery stack, busbars coupled to the holder member and electrically connected to the battery stack, and an overlap region in which at least some of lead regions of the plurality of battery cells of the battery stack overlap one another is formed, in which the overlap region is attached to and in close contact with the busbar.

### CROSS-REFERENCE TO RELATED APPLICATION

This application claims priority to and the benefit of Korean Patent Applications No. 10-2024-0076566 and No. 10-2025-0017451 filed in the Korean Intellectual Property Office on Jun. 12, 2024 and Feb. 11, 2025, respectively, the entire contents of which are incorporated herein by reference.

### TECHNICAL FIELD

The present disclosure relates to a battery module, and more particularly, to a battery module including a pouch-type battery cell.

### BACKGROUND ART

In order to satisfy the marketability of battery modules mounted in electric vehicles, it is not only necessary to charge the battery modules sufficiently with electrical energy, but also to reduce the time required to charge the battery modules. Further, it is necessary to meet additional requirements, such as, ensuring that a temperature of the battery module is within an appropriate range during operation of the battery module.

In order to electrically connect the battery module to another battery module or other external components, the battery module is generally provided with a busbar that facilitates the electrical connection. In the related art, the busbar generally has a structure in which two opposite ends thereof are bent in order to maximize an energy density of the battery module and minimize damage to a terrace portion of a battery cell in the battery module. This configuration degrades efficiency in discharging (e.g., to the outside) thermal energy, which is generated in the battery module and the busbar.

### SUMMARY

The present disclosure has been made in an effort to change an electrical connection structure between a busbar, which is provided in a battery module, and a lead provided on a battery cell, thereby improving heat dissipation efficiency without affecting an energy density of the battery module.

In order to achieve the above-mentioned object, one aspect of the present disclosure provides a battery module including: a battery stack including a plurality of battery cells stacked along a first axis, and one or more pad members provided between the plurality of battery cells; a holder member provided at one side of the battery stack with respect to a second axis intersecting the first axis; and busbars coupled to the holder member and electrically connected to the battery stack, in which the plurality of battery cells each have a lead region protruding outward, attached to, and in close contact with the busbar, in which the lead region viewed from a location spaced apart from the lead region along the second axis, an overlap region in which at least some of the lead regions of the plurality of battery cells overlap one another is formed, and in which the overlap region is attached to and in close contact with the busbar.

Some of the lead regions of the plurality of battery cells may be attached to and in close contact with the busbars in a state in which some of the lead regions of the plurality of battery cells are spaced apart from the other lead regions along the first axis.

Regions of the busbars to which the lead regions of the plurality of battery cells are attached and in close contact with may be provided on one plane formed in a direction intersecting the second axis.

The holder member may have a holder concave-convex portion provided in a peripheral region of the holder member and having a shape protruding toward the busbar or a shape recessed away from the busbar, and the busbar may have a busbar concave-convex portion provided at a position corresponding to the holder concave-convex portion, the busbar concave-convex portion having a shape corresponding to the holder concave-convex portion.

The holder member may have a holder clip portion provided in a peripheral region of the holder member and having a shape protruding toward the busbar, and a partial region of the busbar may be provided to overlap the holder clip portion based on the holder clip portion being viewed from a location spaced apart from the holder clip portion along the second axis.

The battery module may further include: a first conductive sheet provided to face the busbar with the lead region of one of the plurality of battery cells interposed between the first conductive sheet and the busbar, the first conductive sheet being provided to be attached to and in close contact with the lead region or the busbar and containing a thermally conductive material.

An outer surface of the busbar with respect to the second axis may be provided on one plane formed in a direction intersecting the second axis.

The first conductive sheet may be configured to cover an entire region in which the lead region of one of the plurality of battery cells is attached to and in close contact with the busbar.

The busbar may include: a busbar body region configured to define an outer surface of the busbar with respect to the second axis; and a busbar connection region provided to be spaced apart from the busbar body region with respect to the second axis, and the busbar connection region may extend in parallel with the outer surface of the busbar body region with respect to the second axis.

The busbar connection region may be provided to be spaced apart from the busbar body region with respect to a third axis intersecting the first and second axes.

Some of the regions of the busbars with which the lead regions are in close contact may be provided on a first plane intersecting the second axis, and some of the other regions of the busbars with which the lead regions are in close contact may be provided on a second plane spaced apart from the first plane along the second axis.

The second plane may be provided inward of the first plane with respect to the second axis, and the overlap region may be in close contact with the region of the busbar provided on the second plane.

The battery module may further include: an end cap spacing member extending outward of the busbar with respect to the second axis and having a through-hole configured to accommodate the first conductive sheet; and an end cap member provided to face the busbar with the end cap spacing member interposed between the busbar and the end cap member, the end cap member being attached to and in close contact with the first conductive sheet.

The end cap member may include: a cap body configured to define a body of the end cap member and containing an electrically conductive material; and an insulation sheet provided between the cap body and the first conductive sheet, the insulation sheet attached to and in close contact with the first conductive sheet, the cap body, and the end cap spacing member, and containing an electrically non-conductive material.

The battery module may further include: a second conductive sheet attached to and in close contact with one side surface of the cap body and containing a thermally conductive material.

The second conductive sheet may be attached to and in close contact with one side surface of the cap body along a third axis intersecting the first and second axes.

According to an example of the present disclosure a battery module may include: a battery stack comprising a plurality of battery cells stacked along a first axis, the plurality of battery cells each having a lead region; a holder member provided at a first side of the battery stack; a plurality of busbars coupled to the holder member and electrically connected to the battery stack; and an overlap region in which some of the lead regions of the plurality of battery cells overlap one another. The lead region of each of the battery cells may be attached to one of the plurality of busbars.

The overlap region may be attached to one of the plurality of busbars.

According to an example of the present disclosure a battery module may include: a battery stack comprising a plurality of battery cells, each of the plurality of battery cells having a lead region; a plurality of busbars electrically connected to the battery stack; and an overlap region in which some of the lead regions of the plurality of battery cells overlap one another. The lead region of each of the battery cells may be attached to one of the plurality of busbars. The overlap region is attached to one of the plurality of busbars.

The battery module may further comprise a holder member provided at one side of the battery stack. The plurality of busbars may be coupled to the holder member.

According to various examples the present disclosure, it is possible to change the electrical connection structure between the busbar, which is provided in the battery module, and the lead provided on the battery cell, thereby improving heat dissipation efficiency without affecting the energy density of the battery module.

### BRIEF DESCRIPTION OF THE DRAWINGS

FIG. 1 is a perspective view of a battery module according to an example of the present disclosure.

FIG. 2 is an exploded perspective view illustrating components provided at one side of a battery stack based on a second direction in the battery module according to an example of the present disclosure.

FIG. 3 is an enlarged view illustrating a coupling structure between a holder member, a busbar, and a lead region of the battery module according to an example of the present disclosure.

FIG. 4 is a view illustrating a coupling structure between the holder member and the busbar of the battery module according to an example of the present disclosure.

FIG. 5 is an enlarged view illustrating a partial region in FIG. 4.

FIG. 6 is an enlarged view illustrating a state in which a first conductive sheet is tightly attached to the busbar and the lead region of the battery module according to an example of the present disclosure.

FIG. 7 is an enlarged view illustrating a state in which the first conductive sheet is tightly attached to an end cap member of the battery module according to an example of the present disclosure.

FIG. 8 is a cross-sectional view illustrating a coupling structure between the components provided at one side of the battery stack based on the second direction and peripheral regions thereof in the battery module according to an example of the present disclosure.

FIG. 9 is a cross-sectional view illustrating another example of the coupling structure between the busbar and the lead region of the battery module according to an example of the present disclosure.

FIG. 10 is a perspective view illustrating another example of the coupling structure between the busbar and the lead region of the battery module according to an example of the present disclosure.

FIG. 11 is a perspective view of a side plate provided in the battery module according to an example of the present disclosure.

FIG. 12 is a first cross-sectional view illustrating a state in which the battery module according to an example of the present disclosure is cut in a direction perpendicular to a third direction.

FIG. 13 is a second cross-sectional view illustrating a state in which the battery module according to an example of the present disclosure is cut in the direction perpendicular to the third direction.

FIG. 14 is an enlarged cross-sectional view illustrating a state in which the side plate and the surrounding components thereof in the battery module according to an example of the present disclosure are cut in a direction perpendicular to the second direction.

FIGS. 15A-15C are views illustrating various examples of a shape of a rib section of the side plate and a shape of a region in which the rib section and a partition wall section are connected.

### DETAILED DESCRIPTION

Hereinafter, a battery module according to an example of the present disclosure is described with reference to the drawings. When a component, device, element, or the like of the present disclosure is described as having a purpose or performing an operation, function, or the like, the component, device, or element should be considered herein as being “configured to” meet that purpose or perform that operation or function.

### Battery Module

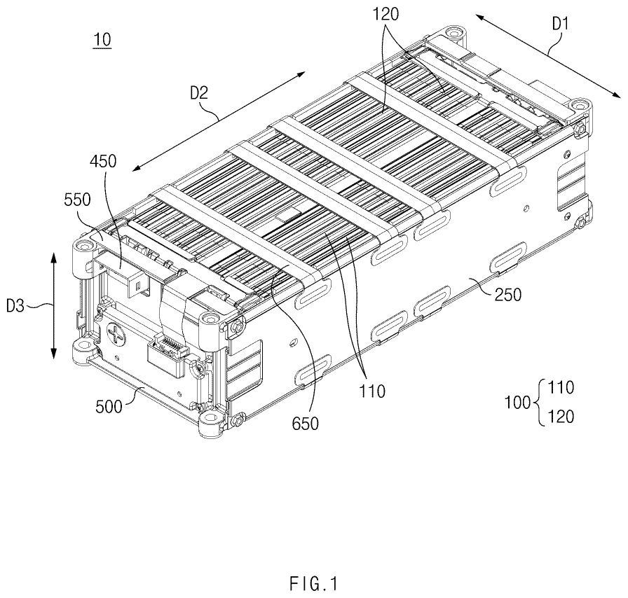

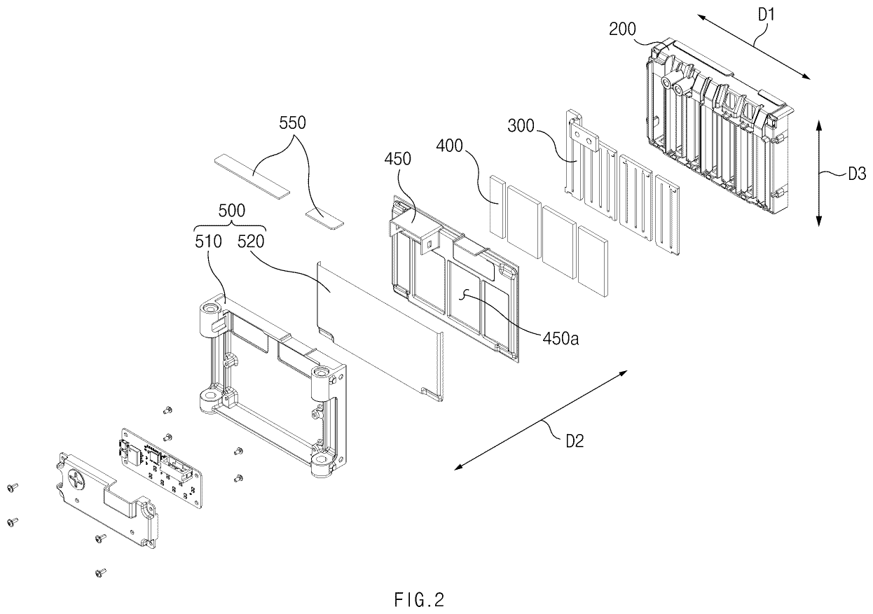

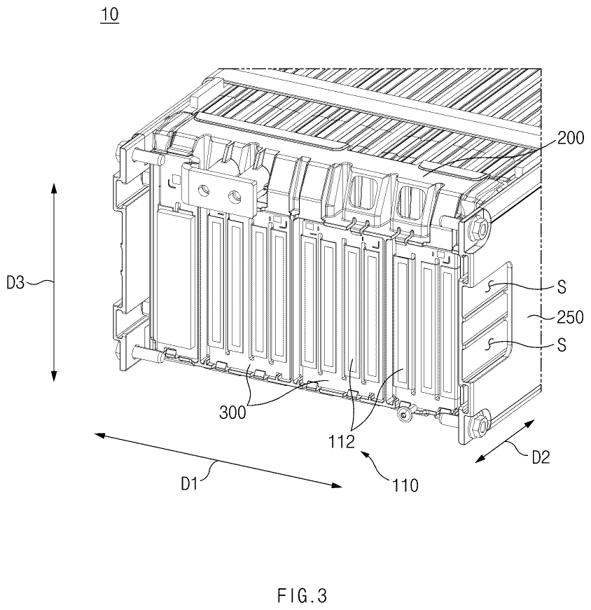

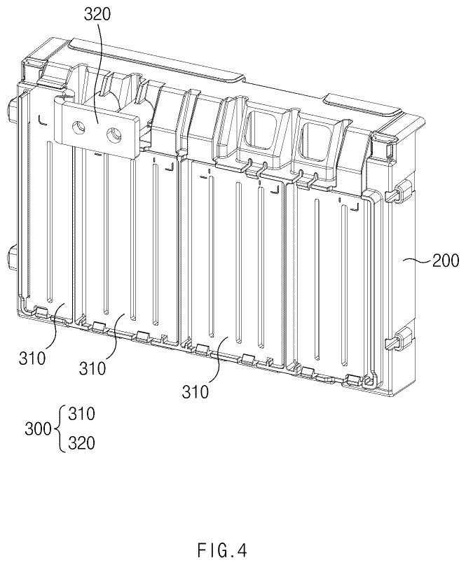

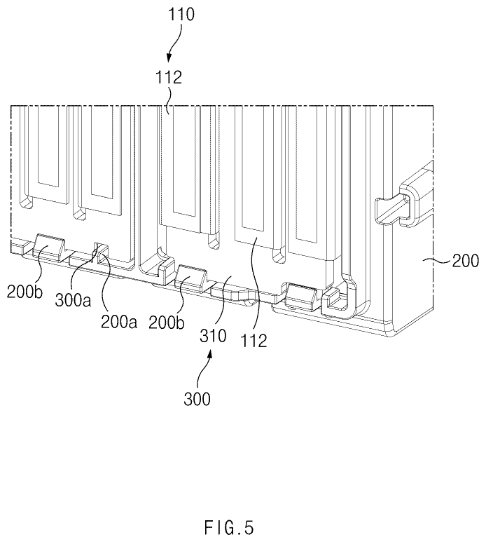

FIG. 1 is a perspective view of a battery module according to an example of the present disclosure. FIG. 2 is an exploded perspective view illustrating components provided at one side of a battery stack based on a second direction in the battery module according to an example of the present disclosure. FIG. 3 is an enlarged view illustrating a coupling structure between a holder member, a busbar, and a lead region of the battery module according to an example of the present disclosure. FIG. 4 is a view illustrating a coupling structure between the holder member and the busbar of the battery module according to an example of the present disclosure. FIG. 5 is an enlarged view illustrating a partial region in FIG. 4.

With reference to the drawings, a battery module 10 according to an example of the present disclosure may include a battery stack 100 including a plurality of battery cells 110 stacked in a first direction D1 or along a first axis D1. The battery module 10 may include one or more pad members 120 provided between the plurality of battery cells 110. For example, the battery cell 110 may be a pouch-type secondary battery. In addition, for example, the battery stack 100 may have a structure in which two battery cells 110 and one pad member 120 are alternately stacked. The pad member 120 may be configured to press the battery cells 110 so that predetermined surface pressure is applied to the battery cells 110 in the battery stack 100.

In addition, the battery module 10 may further include a holder member 200 provided at one side of the battery stack 100 based on a second direction D2 or along a second axis D2. The second axis D2 may intersect the first axis D1. The battery module 10 may include busbars 300 assembled to the holder member 200 and electrically connected to the battery stack 100. The second axis D2 may perpendicularly intersect the first axis D1. The busbar 300 may be configured to mediate or facilitate the electrical connection between the battery module 10 and external components.

The plurality of battery cells 110 may have lead regions 112 protruding outward, tightly attached to the busbars 300 (e.g., attached to and in close contact with the busbars 300), and electrically connected to the busbars 300. More specifically, as illustrated in FIG. 5 and the like, the lead region 112 may include a first section configured to penetrate (e.g., extend through) the busbar 300 and protruding or extending along the second axis D2, and a second section bent along the first axis D1 (e.g., bent relative to the first section or second axis D2 and extending along the first axis D1) from the first section and tightly attached to (e.g., attached to and in close contact with) an outer surface of the busbar 300. For example, the battery cell 110 may extend along the second axis D2 as the longitudinal direction, and the lead region 112 may be provided at an end of each of the plurality of battery cells 110 along the second axis D2.

For example, the busbar 300 and the lead region 112 may be fixed to each other by welding. As described above, the battery cell 110 may be a pouch-type secondary battery. In this case, the battery cell 110 may further include a terrace region 114 configured by joining exterior materials that constitute exterior materials of the pouch-type secondary battery. The lead region 112 may protrude outward through the terrace region 114.

According to an example of the present disclosure, when the lead region 112 is viewed from a location spaced apart from the lead region 112 along the second axis D2, there may be overlap regions 116 in which the lead regions 112 of at least some of the plurality of battery cells 110 are provided to overlap one another. The overlap region 116 may be tightly attached to or in close contact with the busbar 300. For example, the overlap region 116 may be welded to the busbar 300. Therefore, in the regions in which the overlap regions 116 are fixed to the busbars 300, the lead regions 112 of some of the plurality of battery cells 110 which define the overlap regions 116 (e.g., the lead regions 112 of a first group of battery cells 110 defining the overlap region 116), may be tightly attached directly to the busbars 300, and the lead regions 112 of others of the battery cells 110 which define the overlap regions 116 (e.g., the lead regions 112 of a second group of battery cells 110 defining the overlap region 116), may be provided to face the busbars 300 with the lead regions 112 of some of the battery cells 110 (e.g., the lead regions 112 of the first group of battery cells 110), which are tightly attached directly to the busbars 300, interposed between the lead regions 112 of the others (e.g., the lead regions 112 of the second group of battery cells 110) of the battery cells 110 and the busbars 300. Most particularly, the above-mentioned overlap region 116 may be formed only at one position at one side of the battery module 10 based on or along the second axis D2. Because one of the two lead regions 112, which define the overlap region 116, is provided to face the busbar 300 with the other lead region 112 interposed therebetween, one lead region 112 may not be technically considered as being tightly attached to or in close contact with the busbar 300. Nevertheless, in the present specification, both of the two lead regions 112, which define the overlap region 116, are defined as being tightly attached to or in close contact with the busbar 300.

As described above, according to an example of the present disclosure, some of the plurality of lead regions 112 may be electrically connected to the busbars 300 through the overlap regions 116, such that the busbar 300 may have a flat shape as a whole without having a bent shape. In other words, a width of the battery stack 100 (e.g., along the first axis D1) and a width of the busbar 300 (e.g., along the first axis D1) may correspond to each other. In this case, according to an example of the present disclosure, some of the lead regions 112 of the battery cells 110, which constitute the battery stack 100, define the overlap regions 116 and are connected to the busbars 300. Therefore, the electrical connection between the lead regions 112 and the busbars 300 may be implemented without bending two opposite ends of the busbar 300 based along the second axis D2 and then tightly attaching the lead regions 112 of the battery cells 110, which are disposed at two opposite ends along the second axis D2, to the two opposite bent ends of the busbar 300.

According to an example of the present disclosure, some of the other lead regions 112 of the plurality of battery cells 110, which exclude the components for defining the overlap regions 116, may be tightly attached to (e.g., and in close contact with) the busbars 300 while being spaced apart from the other lead regions 112 in the first direction D1.

In addition, with reference to FIGS. 3-5, the holder member 200 of the battery module 10 according to an example of the present disclosure may have a holder concave-convex portion 200a provided in a peripheral region of the holder member 200 and having a shape protruding toward the busbar 300 or a shape recessed away from the busbar 300. FIGS. 3-5 illustrate states in which the holder concave-convex portion 200a protrudes toward the busbar 300.

In addition, in order to correspond to the shape of the holder concave-convex portion 200a, the busbar 300 may have a busbar concave-convex portion 300a formed at a position corresponding to the holder concave-convex portion 200a. The busbar concave-convex portion 300a may have a shape corresponding to the holder concave-convex portion 200a. The configuration in which the busbar concave-convex portion 300a has the shape corresponding to the holder concave-convex portion 200a may be understood as i) a configuration in which the busbar concave-convex portion 300a has a recessed shape when the holder concave-convex portion 200a has a protruding shape and ii) a configuration in which the busbar concave-convex portion 300a has a protruding shape when the holder concave-convex portion 200a has a recessed shape. The holder concave-convex portion 200a and the busbar concave-convex portion 300a may be configured to dispose the busbar 300 at an exact position during a process of assembling the busbar 300 to the holder member 200.

In addition, the holder member 200 may have a holder clip portion 200b provided in a peripheral region of the holder member 200 and having a shape protruding toward the busbar 300. The holder clip portion 200b may be configured to prevent the busbar 300 from being withdrawn from the holder member 200 after the busbar 300 is assembled or coupled to the holder member 200. In order to achieve the above-mentioned object, when the holder clip portion 200b and the surrounding components thereof are viewed from a location spaced apart from the holder clip portion 200b and the surrounding components thereof along the second axis D2, a partial region of the busbar 300 may be provided to overlap the holder clip portion 200b. Therefore, according to an example of the present disclosure, in case that the busbar 300 is about to move outward from the holder member 200 along the second axis D2, the state in which the busbar 300 is assembled to the holder member 200 may be maintained by interference between the busbar 300 and the holder clip portion 200b. The holder clip portion 200b may have a clip or hook shape, which may be deformed when an external force is applied inward along the second axis D2, so that the busbar 300 may push the holder clip portion 200b and be seated on the holder member 200 during the process of assembling the busbar 300 to the holder member 200.

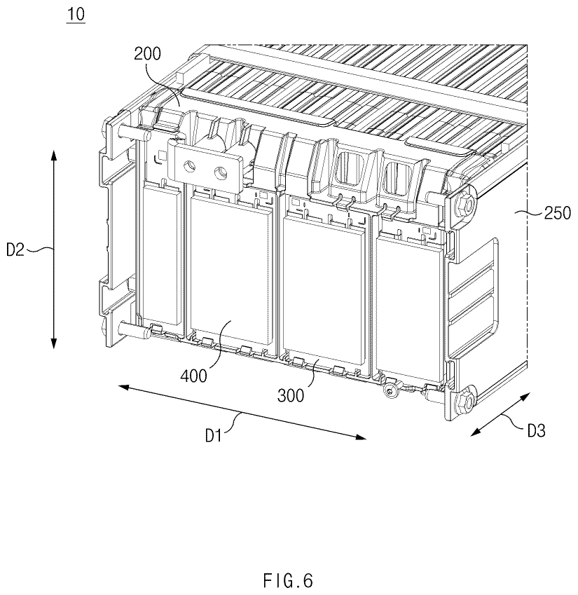

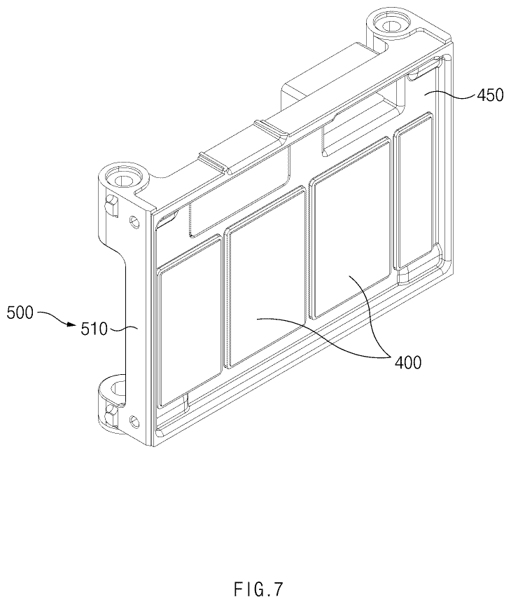

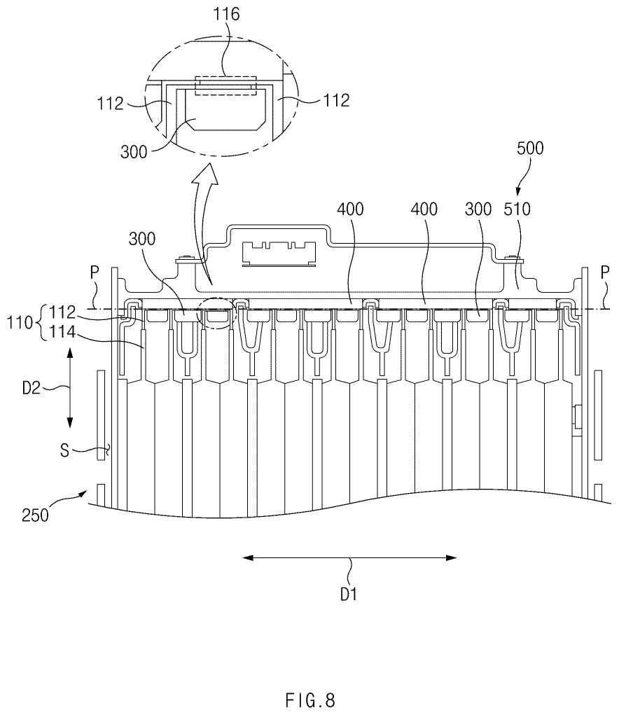

FIG. 6 is an enlarged view illustrating a state in which a first conductive sheet is tightly attached to (e.g., attached to and in close contact with) the busbar and the lead region of the battery module according to an example of the present disclosure. FIG. 7 is an enlarged view illustrating a state in which the first conductive sheet is tightly attached to an end cap member of the battery module according to an example of the present disclosure. FIG. 8 is a cross-sectional view illustrating a coupling structure between the components provided at one side of the battery stack based on the second direction and peripheral regions thereof in the battery module according to an example of the present disclosure.

As described above, according to an example of the present disclosure, the busbar 300 may have a flat shape as a whole. More specifically, as illustrated in FIG. 8 and the like, according to one or some embodiments of the present disclosure, the regions of the busbars 300 to which the lead regions 112 are tightly attached (e.g., in close contact with) may be provided on one or a single plane P formed in a direction perpendicularly intersecting the second axis D2. More particularly, the entire outer surface of the busbar 300 along the second axis D2 may be provided on one or a single plane P formed in the direction perpendicularly intersecting the second axis D2.

With reference to FIGS. 6-8, the battery module according to an example of the present disclosure may further include first conductive sheets 400 provided to face the busbars 300 with the lead regions 112 (e.g., of at least one or some of the plurality of battery cells 110) interposed therebetween, the first conductive sheet 400 being tightly attached to (e.g., in close contact with) the lead region 112 or the busbar 300. The first conductive sheet 400 may be configured to serve to receive thermal energy from the busbar 300 or the lead region 112 and discharge the thermal energy to the outside. Therefore, the first conductive sheet 400 may contain or be made of a thermally conductive material. As illustrated in FIG. 8, the first conductive sheet 400 may be provided to cover and be tightly attached to (e.g., in close contact with) the entire region in which the lead region 112 is tightly attached to (e.g., in close contact with) the busbar 300.

With reference to FIG. 4, the busbar 300 may be divided into a plurality of regions. More specifically, the busbar 300 may further include busbar body regions 310 configured to define an outer surface with respect to the second axis D2, and a busbar connection region 320 provided to be spaced apart from the busbar body regions 310 along the second axis D2. All the above-mentioned descriptions related to the outer surface of the busbar 300 with respect to the second axis D2 may be the description of the outer surface of the busbar body region 310 with respect to the second axis D2. According to an example of the present disclosure, the busbar connection region 320 may extend in parallel with the outer surface of the busbar body region 310 with respect to the second axis D2. This configuration may be understood as a configuration in which a thickness direction of the busbar connection region 320 and a thickness direction of the busbar body region 310 are parallel to each other in case that a direction of the busbar 300 having a smallest width is defined as the thickness direction. FIG. 4 illustrates a state in which the thickness direction of the busbar body region 310 and the thickness direction of the busbar connection region 320 are parallel to the second axis D2.

The busbar connection region 320 may be configured to be coupled to another battery module other than the battery module 10. More specifically, a through-hole may be formed through the busbar connection region 320 in the thickness direction of the busbar connection region (e.g., along the second axis D2). When a coupling member, such as a bolt member, is fastened to the above-mentioned through-hole, the battery module 10 may be coupled to another battery module. In addition, for example, the busbar connection region 320 may be provided to be spaced apart from the busbar body region 310 along a third axis D3 intersecting the first and second axes D1 and D2. In this case, the third axis D3 may perpendicularly intersect the first axis D1 and the axis direction D2.

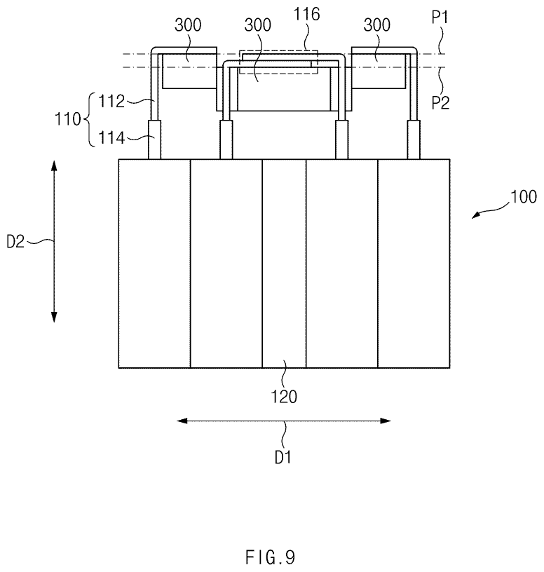

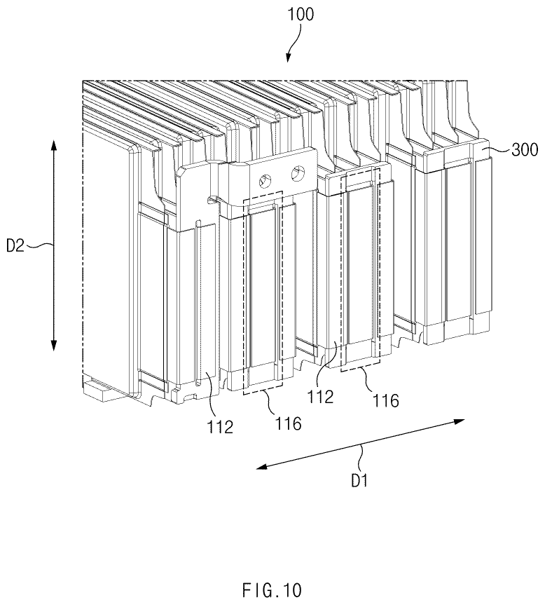

FIG. 9 is a cross-sectional view illustrating another example of the coupling structure between the busbar and the lead region of the battery module according to an example of the present disclosure. FIG. 10 is a perspective view illustrating another example of the coupling structure between the busbar and the lead region of the battery module according to an example of the present disclosure.

According to another example of the present disclosure, the regions of the busbars 300 to which the lead regions 112 are tightly attached may be provided on a plurality of planes instead of a single plane. More specifically, as illustrated in FIGS. 9 and 10, according to another example of the present disclosure, some of the regions of the busbars 300 to which the lead regions 112 are tightly attached may be provided on a first plane P1 formed in a direction perpendicularly intersecting the second axis D2, and some of the other regions of the busbars 300 to which the lead regions 112 are tightly attached may be provided on a second plane P2 spaced apart from the first plane P1 along the second axis D2. More specifically, the second plane P2 may be provided inward of the first plane P1 with respect to the second axis D2. The above-mentioned overlap region 116 may be tightly attached to the region of the busbar 300 provided on the second plane P2. In other words, as illustrated in FIGS. 9 and 10, according to another example of the present disclosure, at least a partial region of the outer surface of the busbar 300 with respect to the second axis D2 may have a shape recessed inward with respect to the second axis D2.

According to another embodiment of the present disclosure illustrated in FIGS. 9 and 10, the stability in joining the overlap region 116 and the busbar 300 may be further improved. In other words, as described above, the overlap region 116 is a region in which the two lead regions 112 overlap each other. The lead regions 112 provided in the overlap region 116 needs to have the second section that is bent so as to extend along the first axis D1 and has a relatively long length so that an area of the region, in which the overlap region 116 and the busbar 300 are tightly attached to each other, is substantially identical to an area of the region in which the other electrode lead 112 in the overlap region 116 and the busbar 300 are tightly attached to each other. To this end, according to another example of the present disclosure, a part of the outer surface of the busbar 300 with respect to the second axis D2 may have a shape which is recessed inward with respect to the second axis D2. In another example of the present disclosure, the first conductive sheet 400 may be provided to cover and be tightly attached to (e.g., in close contact with) the entire region in which the lead region 112 is tightly attached to the busbar 300. In this case, the section of the first conductive sheet 400, which is tightly attached to the overlap region 116, may have a shape recessed inward with respect to the second axis D2.

With reference back to FIGS. 1 and 2, the battery module 10 according to an example of the present disclosure may further include an end cap spacing member 450 provided or extending outward from the busbar 300 with respect to the second axis D2 and having through-holes 450a configured to accommodate the first conductive sheets 400, and an end cap member 500 provided to face the busbars 300 with the end cap spacing member 450 and the first conductive sheets 400 interposed therebetween. The end cap member 500 may be tightly attached to (e.g., in close contact with) the first conductive sheets 400. Therefore, according to an example of the present disclosure, the thermal energy transferred from the busbar 300 and the lead region 112 to the first conductive sheet 400 may be transferred back to the end cap member 500.

The end cap member 500 may be divided into a plurality of regions. More specifically, the end cap member 500 may include a cap body 510 configured to define a body of the end cap member 500 and containing an electrically conductive material, and an insulation sheet 520 provided between the cap body 510 and the first conductive sheet 400, tightly attached to (e.g., in close contact with) the first conductive sheet 400, the cap body 510, and the end cap spacing member 450, and containing an electrically non-conductive material.

In addition, as illustrated in FIGS. 1 and 2, the battery module 10 according to an example of the present disclosure may further include second conductive sheets 550 tightly attached to (e.g., in close contact with) one side surface of the cap body 510 and containing a thermally conductive material. The second conductive sheet 550 may be configured to receive thermal energy transferred to the end cap member 500 and discharge the thermal energy to the outside (e.g., an exterior of the battery module 10). For example, the second conductive sheet 550 may be tightly attached to (e.g., in close contact with) one side surface of the cap body 510 with respect to the third axis D3.

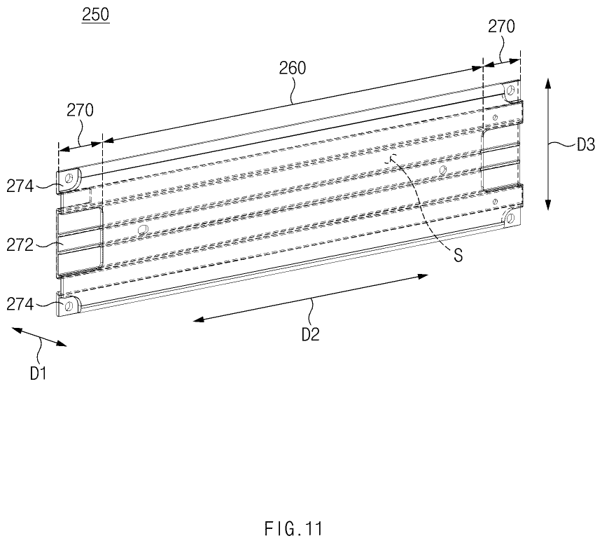

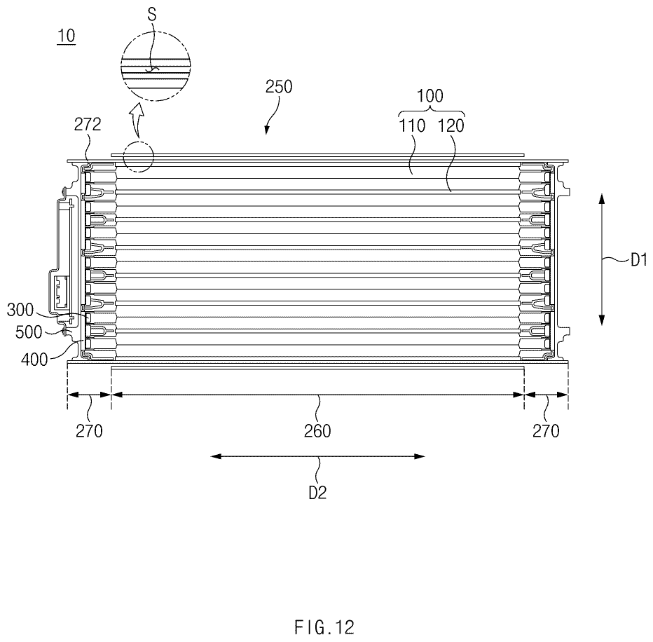

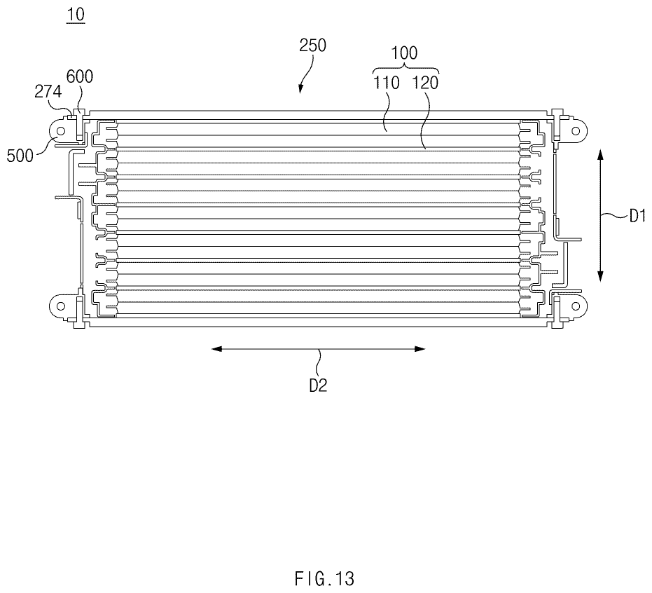

FIG. 11 is a perspective view of a side plate provided in a battery module according to an example of the present disclosure. FIG. 12 is a first cross-sectional view illustrating a state in which a battery module according to an example of the present disclosure is cut in a direction perpendicular to the third direction. FIG. 13 is a second cross-sectional view illustrating a state in which a battery module according to an example of the present disclosure is cut in the direction perpendicular to the third direction.

With reference to FIGS. 1 and 11, a battery module 10 according to an example of the present disclosure may further include side plates 250 respectively provided at two opposite sides of the battery stack 100 with respect to the first axis D1. The side plates 250 may be configured to apply predetermined surface pressure to the battery cells 110 by pressing the battery stack 100 inward along or with respect to the first axis D1.

In particular, the side plate 250 according to an example of the present disclosure may have a structure capable of implementing a weight reduction, increasing physical rigidity, and minimizing a difference in displacement amount with respect to the first axis D1 between a central region of the side plate 250 with respect to the second axis D2 and a peripheral region of the side plate 250 with respect to the second axis D2.

In order to achieve the above-mentioned object, according to an example of the present disclosure, extension spaces S may be formed in the side plate 250 and extend in one direction. More specifically, the plurality of battery cells 110 in the battery stack 100 may each have the lead region 112 provided at one side of each of the plurality of battery cells with respect to the second axis D2 and protruding along the second axis D2, and the extension space S may extend along the second axis D2 as a longitudinal direction.

In case that the battery cell extends along the second axis D2 as the longitudinal direction, the battery cell is longest along or with respect to the second axis D2. Therefore, during the operating process of the battery module, the volume of the battery stack may vary relatively significantly depending on the regions with respect to the second axis D2. In other words, the volume of the battery stack may be greatly changed in the central region with respect to the second axis D2, whereas the volume of the battery stack may be relatively slightly changed in the peripheral region with respect to the second axis D2. This causes a problem in which the surface pressure applied to the battery stack is not uniform from region to region.

The side plate 250 according to an example of the present disclosure may be configured to solve the above-mentioned problem. In other words, according to an example of the present disclosure, the side plate 250 is manufactured so that the extension space S extends along the second axis D2, which may solve the problem in which the surface pressure is not uniform from region to region with respect to the longitudinal direction (i.e., the second axis D2) of the battery stack 100. An additional feature of the side plate 250 for solving the above-mentioned problem is described below.

The side plate 250 including the extension space S may be manufactured in various ways. For example, the side plate 250 may be manufactured by extrusion. In case that the side plate 250 is manufactured by extrusion, the side plate 250 may be manufactured so that the extension spaces S and the regions surrounding the extension spaces S may have constant cross-sectional shapes. In case that the side plate 250 is manufactured by extrusion, the above-mentioned extension spaces S may extend to two opposite ends of the side plate 250 with respect to the second axis D2 because of the nature of the extrusion. This configuration may be understood as a configuration in which the extension spaces S communicate with the outside through the two opposite ends of the side plate 250 with respect to the second axis D2.

The side plate 250 may be divided into a plurality of regions. More specifically, with reference to FIGS. 1, 11, 12, and the like, the side plate 250 may include a central plate region 260 provided to face the battery stack 100 along the first axis D1, and peripheral plate regions 270 connected to two opposite ends of the central plate region 260 with respect to the second axis D2. In other words, as described below, the central plate region 260 of the side plate 250 may be a region configured to apply surface pressure to the battery cells 110 by directly pressing the battery stack 100, and the peripheral plate regions 270 of the side plate 250 may be regions coupled to the end cap member 500.

In this case, according to an example of the present disclosure, the peripheral plate region 270 may have processed sections 272 each having a smaller thickness with respect to the first axis D1 than the other regions adjacent to the processed section 272. For example, the processed section 272 may have a shape made by cutting an outer surface of the side plate 250 with respect to the first axis D1. Therefore, in the processed section 272, the above-mentioned extension space S may be opened to the outside with respect to the first axis D1. As described above, because the peripheral plate region 270 is not configured to directly press the battery stack 100, the peripheral plate region 270 may require relatively less physical rigidity than the central plate region 260. Therefore, in case that the processed section 272 is formed in the peripheral plate region 270, it is possible to reduce an overall weight of the side plate 250 while ensuring the physical rigidity required for the side plate 250 to press the battery stack 100. Because the central plate region 260 is the region configured to directly press the battery stack 100, the processed section 272 may not be formed in the central plate region 260. More specifically, the processed section 272 may be spaced apart from the central plate region 260 in the second direction D2.

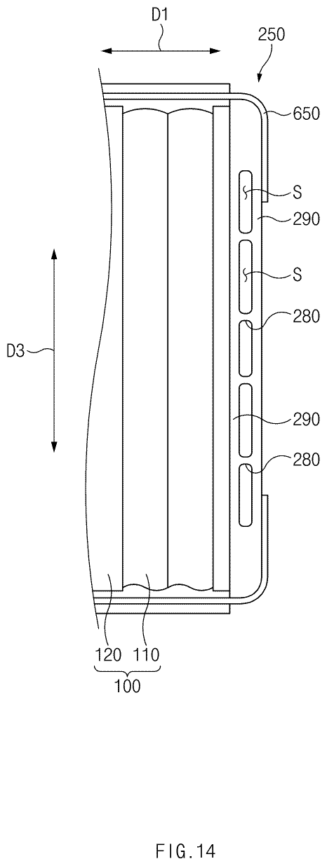

FIG. 14 is an enlarged cross-sectional view illustrating a state in which the side plate and the surrounding components thereof in the battery module according to an example of the present disclosure are cut in a direction perpendicular to the second axis.

With reference to FIG. 14 and the like, according to an example of the present disclosure, the extension spaces S formed in the side plate 250 may be provided as a plurality of extension spaces S spaced apart from one another with respect to the third axis D3 and intersecting the first and second axes D1 and D2. Based on FIG. 14, the plurality of extension spaces S may be spaced apart from one another in an upward/downward or vertical direction.

In addition, the side plate 250 may include a plurality of rib sections 280 configured to separate the two extension spaces S adjacent to each other along the third axis D3, and partition wall sections 290 connected to two opposite ends of the rib sections 280 with respect to the first axes D1 and extending along the third axis D3. For example, the plurality of rib sections 280 may have the same thickness with respect to the third axis D3. However, as another example, at least some of the plurality of rib sections 280 may have different thicknesses with respect to the third axis D3. For example, the rib section 280 may have a thickness with respect to the third axis D3 that increases as the distance from the central region of the side plate 250 with respect to the third axis D3 decreases.

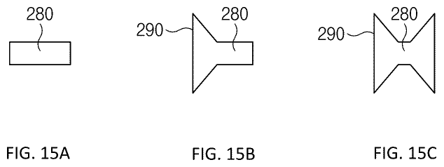

FIGS. 15A-15C are views illustrating various examples of a shape of a rib section of the side plate and a shape of a region in which the rib section and a partition wall section are connected.

With reference to FIGS. 14 and 15A, the thickness of the rib section 280 with respect to the third axis D3 may be constant. However, the thickness of the rib section 280 with respect to the third axis D3 may vary from region to region. For example, with reference to FIGS. 14, 15B, and 15C, the thickness with respect to the third axis D3 of the portion of the rib section 280 connected to the partition wall section 290 may be larger than the thickness with respect to the third axis D3 of each of the other portions of the rib section 280. From the point of view of the partition wall section 290, this configuration may be understood as a configuration in which the thickness with respect to the first axis D1 of the portion of the partition wall section 290 connected to the rib section 280 is larger than the thickness with respect to the first axis D1 of each of the other portions of the partition wall section 290. FIG. 15B illustrates a state in which a thickness of only one of the two opposite sides of the rib section 280 connected to the partition wall section 290 is relatively large. FIG. 15C illustrates a state in which thicknesses of the two opposite sides of the rib section 280 connected to the partition wall section 290 are relatively large.

FIG. 7 illustrates a state in which the extension space S is formed along the second axis D2 as the longitudinal direction and extends in the direction perpendicularly intersecting the first and third axes D1 and D3. However, unlike the configuration illustrated in FIG. 7, according to another example, the extension space S may extend in a longitudinal direction having a predetermined angle with respect to i) the first axis D1, ii) the second axis D2 perpendicularly intersecting the first axis D1, and iii) the third axis D3 perpendicularly intersecting the first and second axes D1 and D2.

With reference to FIGS. 11 and 13, the above-mentioned peripheral plate region 270 may be coupled to the end cap member 500. More specifically, the battery module 10 according to an example of the present disclosure may include the end cap member 500 provided at one side of the battery stack 100 with respect to the second axis D2 and fixedly coupled to the side plate 250, and a penetration member 600 configured to penetrate the side plate 250 and the end cap member 500. In this case, the peripheral plate region 270 may have recessed sections 274 each having a shape further recessed inward with respect to the first axis D1 than the other regions adjacent to the recessed section 274. The penetration member 600 may penetrate the recessed section 274 and the end cap member 500. The penetration member 600 may be a screw member or a bolt member. In this case, at least a part of a head region of the penetration member 600 may be accommodated in a space defined by the recessed section 274. FIG. 11 illustrates a state in which the recessed section 274 is provided in the peripheral plate region 270 and spaced apart from the processed section 272 with respect to the third axis D3 intersecting the first and second axes D1 and D2.

In addition, with reference to FIG. 11, a section between the processed section 272 and the recessed section 274 with respect to the third axis D3 in the peripheral plate region 270 may be integrally connected to the central plate region 260. This configuration may be understood as a configuration in which the central plate region 260 and the section between the processed section 272 and the recessed section 274 with respect to the third axis D3 in the peripheral plate region 270 have shapes considered as being identical to each other.

With reference back to FIG. 1, the battery module 10 according to an example of the present disclosure may further include strip members 650 each having one side coupled to the side plate 250 provided at one of the two opposite sides of the battery stack 100 with respect to the first axis D1, and the other side coupled to the side plate 250 provided at the other of the two opposite sides of the battery stack 100 with respect to the first axis D1. The strip member 650 may be configured to apply surface pressure to the battery stack 100 together with the side plate 250.

The strip member 650 and the side plate 250 may contain or be made of the same metallic material. The strip member 650 and the side plate 250 may be coupled to each other by welding. In case that the strip member 500 and the side plate 400 contain the same metallic material, the welding may be smoothly performed. For example, the strip member 650 and the side plate 250 may contain or be made of aluminum metal. The cap body 510 of the end cap member 500 may also contain or be made of aluminum metal.

The present disclosure has been described with reference to the limited embodiments and the drawings provided herein, but the present disclosure is not limited thereby. The present disclosure may be carried out in various forms by those having ordinary skill in the art, to which the present disclosure pertains, within the technical spirit of the present disclosure and the scope equivalent to the appended claims.

What is claimed is:

1. A battery module comprising:
a battery stack comprising a plurality of battery cells stacked along a first axis and one or more pad members provided between the plurality of battery cells;
a holder member provided at one side of the battery stack with respect to a second axis intersecting the first axis; and
busbars coupled to the holder member and electrically connected to the battery stack,
wherein the plurality of battery cells each have a lead region protruding outward, attached to the busbar, and in close contact with the busbar,
wherein based on the lead region being viewed from a location spaced apart from the lead region along the second axis, an overlap region in which at least some of the lead regions of the plurality of battery cells overlap one another is formed, and
wherein the overlap region is attached to and in close contact with the busbar.

2. The battery module of claim 1, wherein some of the lead regions of the plurality of battery cells are attached to and in close contact with the busbars in a state in which some of the lead regions of the plurality of battery cells are spaced apart from other lead regions of the plurality of battery cells along the first axis.

3. The battery module of claim 1, wherein regions of the busbars to which the lead regions of the plurality of battery cells are tightly attached are provided on one plane intersecting the second axis.

4. The battery module of claim 1, wherein the holder member has a holder concave-convex portion provided in a peripheral region of the holder member and having a shape protruding toward the busbar or a shape recessed away from the busbar and
wherein the busbar has a busbar concave-convex portion provided at a position corresponding to the holder concave-convex portion, the busbar concave-convex portion having a shape corresponding to the holder concave-convex portion.

5. The battery module of claim 1, wherein the holder member has a holder clip portion provided in a peripheral region of the holder member and having a shape protruding toward the busbar and
wherein a partial region of the busbar is provided to overlap the holder clip portion, based on the holder clip portion being viewed from a location spaced apart from the holder clip portion along the second axis.

6. The battery module of claim 1, further comprising:
a first conductive sheet provided to face the busbar with the lead region of one of the plurality of battery cells interposed between the first conductive sheet and the busbar, the first conductive sheet being provided to be attached to and in close contact with the lead region or the busbar and containing a thermally conductive material.

7. The battery module of claim 6, wherein an outer surface of the busbar with respect to the second axis is provided on one plane intersecting the second axis.

8. The battery module of claim 7, wherein the first conductive sheet is configured to cover an entire region in which the lead region of one of the plurality of battery cells is attached to and in close contact with the busbar.

9. The battery module of claim 6, wherein the busbar comprises:
a busbar body region configured to define an outer surface of the busbar with respect to the second axis; and
a busbar connection region provided to be spaced apart from the busbar body region with respect to the second axis and
wherein the busbar connection region extends in parallel with the outer surface of the busbar body region with respect to the second axis.

10. The battery module of claim 9, wherein the busbar connection region is provided to be spaced apart from the busbar body region with respect to a third axis intersecting the first and second axes.

11. The battery module of claim 1, wherein some of the regions of the busbars with which the lead regions are in close contact are provided on a first plane intersecting the second axis, and other regions of the busbars with which the lead regions are in close contact are provided on a second plane spaced apart from the first plane along the second axis.

12. The battery module of claim 11, wherein the second plane is provided inward of the first plane with respect to the second axis, and the overlap region is attached to and in close contact with the region of the busbar provided on the second plane.

13. The battery module of claim 6, further comprising:
an end cap spacing member extending outward of the busbar with respect to the second axis and having a through-hole configured to accommodate the first conductive sheet; and
an end cap member provided to face the busbar with the end cap spacing member interposed between the busbar and the end cap member, the end cap member being attached to and in close contact with the first conductive sheet.

14. The battery module of claim 1, further comprising:
a first conductive sheet provided to face the busbar with the lead region of one of the plurality of battery cells interposed between the first conductive sheet and the busbar, the first conductive sheet being provided to be attached to and in close contact with the lead region or the busbar and containing a thermally conductive material;
an end cap spacing member extending outward of the busbar with respect to the second axis and having a through-hole configured to accommodate the first conductive sheet; and
an end cap member provided to face the busbar with the end cap spacing member interposed between the busbar and the end cap member, the end cap member being attached to and in close contact with the first conductive sheet,
wherein the end cap member comprises:
a cap body configured to define a body of the end cap member and containing an electrically conductive material; and
an insulation sheet provided between the cap body and the first conductive sheet, insulation sheet attached to and in close contact with the first conductive sheet, the cap body, and the end cap spacing member, and containing an electrically non-conductive material.

15. The battery module of claim 14, further comprising:
a second conductive sheet attached to and in close contact with one side surface of the cap body and containing a thermally conductive material.

16. The battery module of claim 15, wherein the second conductive sheet is attached to and in close contact with one side surface of the cap body along a third axis intersecting the first and second axes and.

17. A battery module comprising:
a battery stack comprising a plurality of battery cells stacked along a first axis, the plurality of battery cells each having a lead region;
a holder member provided at a first side of the battery stack;
a plurality of busbars coupled to the holder member and electrically connected to the battery stack; and
an overlap region in which some of the lead regions of the plurality of battery cells overlap one another,
wherein the lead region of each of the battery cells is attached to one of the plurality of busbars.

18. The battery module of claim 17, wherein the overlap region is attached to one of the plurality of busbars.

19. A battery module comprising:
a battery stack comprising a plurality of battery cells, each of the plurality of battery cells having a lead region;
a plurality of busbars electrically connected to the battery stack; and
an overlap region in which some of the lead regions of the plurality of battery cells overlap one another,
wherein the lead region of each of the battery cells is attached to one of the plurality of busbars, and
wherein the overlap region is attached to one of the plurality of busbars.

20. The battery module of claim 19, further comprising:
a holder member provided at one side of the battery stack,
wherein the plurality of busbars are coupled to the holder member.
